(19) United States
(12) Patent Application Publication
(10) Pub. No.: US 2018/0193914 A1
(43) Pub. Date: Jul. 12, 2018

(54) PRODUCTION STATION AND PRODUCTION ARRANGEMENT WITH A TABLE FRAMEWORK FOR PRODUCING BONDED LAYERED BEDS OF MAGNETOCALORIC MATERIAL AND A METHOD OF PRODUCING BONDED LAYERED BEDS OF MAGNETOCALORIC MATERIAL

(71) Applicant: BASF SE, Ludwigshafen (DE)

(72) Inventors: Colman CARROLL, Maxdorf (DE); Dietmar BENDER, Boehl-lggelheim (DE); Markus SCHWIND, Madison, WI (US)

(73) Assignee: BASF SE, Ludwigshafen (DE)

(21) Appl. No.: 15/741,581

(22) PCT Filed: Jun. 28, 2016
(86) PCT No.: PCT/EP2016/065052

§ 371 Date: Jan. 3, 2018

(30) Foreign Application Priority Data
Jul. 6, 2015 (EP) 15175545.1

(51) Int. Cl. B22F 3/03; B30B 15/30; H01F 1/01; H01F 41/02

(52) U.S. Cl. CPC B22F 3/03; B30B 15/30; F25B 2321/0021; H01F 41/02; B32B 2307/208; H01F 1/01

(57) ABSTRACT

The invention relates to a production station for use in producing at least one layered bed, in particular a plurality of layered beds, of a magneto caloric material, the station comprising a frame work and further for arrangement at the frame work the station comprising:—a material receptacle for receiving a particulate magnetocaloric material,—a dosing plate, having at least one intake opening adapted to receive a magneto-caloric material of one layer of the layered bed—at least one reservoir below the at least one intake opening, wherein the reservoir is adapted to receive the one or more layers of the particulate magnetocaloric material, wherein the production station further comprises:—a shutter plate arranged between the reservoir and the dosing plate, wherein the shutter plate is switchable through motion with respect to the dosing plate and wherein the shutterplate is arranged and adapted to at least activate a filling modus, wherein in the filling modus the at least one reservoir is filled with particulate magneto caloric material of the one layer of the layered bed by a switching control of the shutter plate.

The invention relates to a production station according to the preamble part of claim 1 and to a production arrangement according to the preamble part of claim 10 for producing layered beds of magnetocaloric material and to a method for producing layered beds of magnetocaloric material according to the preamble part of claim 12.

Beds of magnetocaloric material usually require precise layering of different magnetocaloric materials on top of one another. In view of the requirements on the layered beds and the small number of experimental prototypes in magnetocaloric appliances, such beds are usually produced manually in laboratories.

The object of the invention is to provide an improved production arrangement and an improved production station for producing layered beds of magnetocaloric material. In particular it is an object of the invention to enable a production of a large amount of layered beds of magnetocaloric materials.

The object is achieved according to a first aspect of the invention with a production station as defined in claim 1. The invention provides a production station adapted for use in a method of producing at least one layered bed of magnetocaloric materials, in particular a number of, preferably bonded, layered beds of magnetocaloric materials, wherein each bed has one or more layers of, preferably different, magnetocaloric materials, and wherein the production station comprises a framework. According to the invention the production station further comprises:
a material receptacle for receiving a particulate magnetocaloric material,
a dosing plate, having at least one intake opening adapted to receive a magnetocaloric material of one layer of the layered bed,
at least one reservoir below the at least one intake opening, wherein the reservoir is adapted to receive the one or more layers of the particulate magnetocaloric material, wherein the production station further comprises:
a shutter plate arranged between the reservoir and the dosing plate, wherein the shutter plate is switchable through motion with respect to the dosing plate and wherein the shutter plate is arranged and adapted to at least activate a filling modus, wherein in the filling modus the at least one reservoir is filled with particulate magnetocaloric material of the one layer of the layered bed by a switching control of the shutter plate, wherein
an amount of particulate magnetocaloric material in the reservoir, after being filled with particulate magnetocaloric material of the one layer of the layered bed in the filling modus of the production station, depends on a filling height of particulate magnetocaloric material within the intake opening of the dosing plate before the filling modus has been active, and wherein
a flow of particulate magnetocaloric material starts with an activation of the filling of the reservoir in the filling modus of the shutter plate, and wherein the flow of particulate magnetocaloric material ends with emptying the intake opening of the dosing plate from a filling height of particulate magnetocaloric material within the intake opening of the dosing plate.

A layered bed of a magnetocaloric material is considered to comprise at least one layer of a magnetocaloric material. In particular, a layered bed of magnetocaloric material can comprise different magnetocaloric materials. A bed at first instance needs not to be bonded according to the terminology of this application. Preferably the at least one layered bed of a magnetocaloric materials is a number of layered beds of magnetocaloric materials, preferably comprising different magnetocaloric materials. Once the layered bed of magnetocaloric material is pressed or heated the layered bed of a magnetocaloric material is termed to be a bonded layered bed. The production station in a preferred development can also provide some kind of bonding means, like a pressing device or a heating device, to manufacture a bonded layered bed from a layered bed.

The framework according to the first aspect of the invention can be any kind of support structure, construction or housing.

The material receptacle can be a material box or the like receptacle. The dosing plate preferably is arranged at the bottom of the material receptacle. In particular a plurality of intake openings each adapted to receive a magnetocaloric material of one layer of the layered bed can be provided. In particular a plurality of reservoirs below the plurality of intake openings assigned to the plurality of layered beds can be provided. The shutter plate is preferably switchable through motion in a parallel to the dosing plate.

The volume of particulate magnetocaloric material, which is received by the at least one reservoir during a dosing in the course of the filling modus depends on a form and the filling height of the at least one intake opening of the dosing plate.

The advantage of the production station according to the first aspect of the invention is that it provides a dosing that is not time depend, as it is usually the case for production devices with shutter plate. Instead the inventive production station functions in that a dosing that depends on a volume of the particulate magnetocaloric material within the at least one intake opening of the dosing plate is provided. Thus, the production station provides a dosing that advantageously allows a very precise dosing of the particulate magnetocaloric material. Such precise dosing is often required in magnetocaloric applications, which is the reason why layered beds of magnetocaloric material are often produced manually. Therefore, the present invention allows a comfortable production scheme that is particularly advantageous for producing layered beds of magnetocaloric material automatically, or to some extent automatically. Furthermore, the production table according to the first aspect of the invention can be by advantageously integrated into a production line, in particular into an already existing production line, and can therefore be used to produce large amounts of layered beds of magnetocaloric material.

According to a second aspect of the invention, a production arrangement for producing layered beds of magnetocaloric material as defined in claim 9 is provided. Therein according to the invention, the production arrangement comprises at least two production stations according to at least one of the claims 1 to 8. According to the invention further therein:
at least one plurality of reservoirs is arranged movable from one production station to another production station of the at least two production stations,
a reservoir shift system arranged and adapted to move the at least one plurality of reservoirs from a first framework of said one production station to a second framework of said another production station or to a pressing framework, comprising a pressing device.

Preferably the reservoir shift system comprises a transport production framework.

In view of structural similarities, the advantages of the production arrangement according to claim 10 are the same as those of the production station according to the first aspect of the invention. But furthermore, at least two production stations can advantageously allow two layered beds of different magnetocaloric material. This can improve the magnetocaloric characteristics of the resulting layered bed of magnetocaloric material in typical applications, as for instance in a cooling device. Using at least two production stations also allows an advantageous using of two different volumes of magnetocaloric material, according to two dosing plates, which can comprise different intake openings as for using different amounts of a respective particulate magnetocaloric material.

The production arrangement of the second aspect of the invention comprises advantageously specialized frameworks. The production station of the first framework provides magnetocaloric material of a first kind and of a first volume, while the production station of the second framework can provide magnetocaloric material of a second kind and of a second volume and/or the pressing framework is arranged to press the pressing pins against the magnetocaloric material of the first kind, of the second kind, or a combination thereof. Thus, the production arrangement can execute multiple processes in parallel, which leads to a faster production of the layered beds of magnetocaloric material. Furthermore, the reservoir shift system enables an automatic or at least to some extent automatic production of the layered beds of magnetocaloric material.

According to a third aspect of the invention, a method of producing layered beds of magnetocaloric material is provided, in particular by using a production station of one of the claims 1 to 9 and/or a production arrangement of one of the claim 10 or 11. According to the invention the method comprises the steps of:
providing a particulate magnetocaloric material received in a material receptacle,
dosing the particulate magnetocaloric material in the dosing plate having at least one intake opening adapted to receive a magnetocaloric material of one layer of the layered bed,
receiving the layered bed of the particulate magnetocaloric material, in particular in at least one reservoir below the at least one intake opening, in particular a plurality of reservoirs below the plurality of intake openings assigned to the plurality of layered beds, wherein the reservoir is adapted to receive the one or more layers of the particulate magnetocaloric material,
activating a filling modus of the reservoirs with the particulate magnetocaloric material by switching control of the shutter plate, in particular a shutter plate arranged between the reservoir and the dosing plate, wherein the shutter plate is switchable through motion with respect to the dosing plate, in particular wherein the shutter plate is switchable through motion in a parallel to the dosing plate, and wherein the shutter plate is arranged and adapted to at least activate the filling modus, wherein in the filling modus the at least one reservoir is filled with particulate magnetocaloric material of the one layer of the layered bed by a switching control of the shutter plate, wherein
an amount of particulate magnetocaloric material in the reservoir after filling of the reservoir in a filling modus of the production station depends on a filling height of particulate magnetocaloric material within the intake opening of the dosing plate before the filling of the reservoirs, and wherein
a flow of particulate magnetocaloric material starts with an activation of the filling of the reservoir in the filling modus of the shutter plate, and wherein the flow of particulate magnetocaloric material ends with emptying the intake opening of the dosing plate from a filling height of particulate magnetocaloric material within the intake opening of the dosing plate

Preferably the dosing plate is arranged at the bottom of the material receptacle. The dosing plate has at least one intake opening, namely preferably a plurality of intake openings each adapted to receive a magnetocaloric material of one layer of the layered bed.

The layered bed of the particulate magnetocaloric material is received in at least one reservoir below the at least one intake opening. In particular a plurality of reservoirs below the plurality of intake openings assigned to the plurality of layered beds is provided.

In the method preferably a filling modus of the reservoirs with the particulate magnetocaloric material can also be deactivated by switching control of the shutter plate.

In particular a shutter plate is arranged between the reservoir and the dosing plate. Preferably the shutter plate is switchable through motion in a parallel to the dosing plate,

The advantages of the method are the same as those of the production station and the production arrangement, since the production station according to claim 1 and the production arrangement according to claim 9 imply the method of producing layer beds of magnetocaloric material according to the third aspect of the invention.

In the following, developments of the production station according to the first aspect of the invention will be described.

In a preferred development the production station provides:
a scraper, which is movable across the entrance of the at least on intake opening at the surface of the dosing plate, such that an excess amount of magnetocaloric material situated between the entrance and the material receptacle is removed from the entrance of the at least on intake opening.

In particular an excess amount of magnetocaloric material is situated between the entrance and the surface of the dosing plate and is removed from the entrance of the at least on intake opening. In a variant of this development, a plurality of intake openings is provided, and all intake openings of the plurality of intake openings in the dosing plate are of a same volume, and are arranged to be always filled exactly to the top. The scraper of this variant is arranged to scrape off the excess amount of magnetocaloric material, so that an exact amount of magnetocaloric material is dosed by the production station.

In a further preferred development the production station comprises a bin and the material receptacle and the dosing plate and/or the shutter plate are further arranged to provide the bin with particulate magnetocaloric material, such that a further scraper or the scraper is arranged to provide the bin with residual particulate magnetocaloric material. In particular, the scraper of this development can be the scraper which is also used in the previous development to remove the excess amount of magnetocaloric material. The particulate magnetocaloric material provided to the bin in this development can be in particular the particulate magnetocaloric material resting in the material receptacle after the metering modus and/or deactivation of the filling modus.

Preferably the bin is for arrangement at the framework. In particular the material receptacle and the dosing plate and/or the shutter plate are further arranged to provide a discharge opening by means of a further scraper or the scraper formed as a wiper. In particular all of the particulate magnetocaloric material resting in the material receptacle after the metering modus and/or deactivation of the filling modus can be wiped to the bin through the discharge opening. In a development of the production station according to the first aspect of the invention, the shutter plate is being arranged and adapted such that the flow of particulate magnetocaloric material ends before a deactivation of the filling of the reservoirs by the shutter plate, and/or the shutter plate is being arranged and adapted such that the filling modus of the reservoirs with the particulate magnetocaloric material is deactivated by a further switching control of the shutter plate. In this development, the shutter plate is configured to move parallel to the dosing plate into a position of the shutter plate before an activation of the filling modus. This deactivation of the filling modus allows a filling of the at least one intake opening without filling the at least one reservoir below the at least one intake opening. Furthermore, the dosing of the production station in this development is particularly precise since not even residual magnetocaloric material remains in the at least one intake opening.

In a further development, the reservoir has a cross-sectional configuration, wherein the cross-section of the reservoir is adapted to the cross-section of the intake opening, in particular wherein the cross-section of the reservoir and the cross-section of the intake opening are of same size and/or of same shape, in particular wherein the cross-section of the reservoir and/or the intake opening are of a shape selected from the group consisting of: circular, oval, triangular, rectangular, quadratic, hexagonal or other polygonal shape. Such an adaptation of the cross-section of the reservoir and the intake opening allows an undisturbed and fast flow of the particulate magnetocaloric material into the reservoir. Thus, the production station of this embodiment can allow a faster production of layered beds of magnetocaloric material.

In a development of the production table, in a filling modus of the shutter plate, the shutter plate has at least one further intake opening, in particular a plurality of further intake openings aligned with and underneath the plurality of intake openings assigned to the plurality of layered beds, wherein the reservoir is adapted to receive the layered bed of the particulate magnetocaloric material through the at least one further intake opening when activated for filling of the reservoirs with the particulate magnetocaloric material and/or in a metering modus of the shutter plate, the shutter plate has at least one further intake opening, in particular a plurality of further intake openings, wherein the at least one further intake openings are not-aligned and underneath the plurality of intake openings assigned to the plurality of layered beds, wherein the shutter plate closes the intake openings of the dosing plate when deactivated for filling of the reservoirs with the particulate magnetocaloric material. Such an at least one further intake opening can improve a directing of the flow of particulate magnetocaloric material into the at least one reservoir. Furthermore, the closing of the intake opening by not-aligning the at least one further intake opening with the at least one intake opening allows a refilling of the at least one intake opening for a further filling modus. Thus, a further filling modus can be prepared while the at least one reservoir is exposed to other processing steps of the production table.

In another development the production station is characterized by a pressing device, in particular wherein the pressing device is arranged at the framework of the production station, and wherein the pressing device is arranged to be pressed against the particulate magnetocaloric material within the reservoirs, in particular wherein the pressing device comprises pressing pins to be pressed against the particulate magnetocaloric material within the reservoirs. A therefore provided pressed magnetocaloric material can have advantageous characteristics for subsequent processing steps, as for instance a sintering, a tempering and a cooling of the pressed magnetocaloric material. In a variant of this development, the pressing device comprises a pressing motor that is arranged to press the pressing pins against the particulate magnetocaloric material within the reservoirs. In an example of this variant, the pressing motor is arranged to press the pressing pins with a certain pressing force, wherein the pressing force can depend on a height of the particulate magnetocaloric material within the reservoir. In a further variant of this development, the pressing pins can be pressed against the particulate magnetocaloric material manually or to some extent automatically.

In a preferred development of the production table, the production station further comprises a controlling device and/or a user interface in form of a man-machine-interface, in particular arranged at the framework, arranged and adapted to control the shutter plate, in particular the activation and/or the deactivation of the filling by the shutter plate, and/or to control the pressing device, preferably by controlling a position of the pressing pins and/or by controlling a pressing force applied to the pressing pins. The controlling device of this development allows an automatic or an at least to some extent automatic production of a layered bed of magnetocaloric material. The controlling device furthermore allows a harmonisation between a pressing modus of the pressing device and the filling modus and therefore avoids an accidental activation of the pressing device during the filling modus of the production table. In a variant of this development, the controlling device comprises the man-machine interface, comprising a user input interface configured to receive a user input and further comprising a display device configured to provide a user with information concerning the production station, in particular concerning current characteristics of the particulate magnetocaloric material during a processing of the production station. In an example of this variant, the user input indicates a pressing force of the pressing device. In a further example of this variant, the user input indicates a duration of the filling modus.

In a further development of the production station, the reservoir is adapted to vibrate during the filling of the reservoir and/or a mounting frame for mounting the plurality of reservoirs to the framework of the production station is adapted to vibrate during the filling of the reservoirs. The vibration can support the magnetocaloric material to settle down in the reservoir, and thus supports a precise production of a layered bed of magnetocaloric material.

In a development, the control device comprises a height sensor arranged and adapted to determine a filling height of magnetocaloric material of the at least one intake opening during the filling mode and to stop a filling of the intake opening with particulate magnetocaloric material if a predetermined filling height is reached. In a variant of this development, the control device is further configured to activate the filling modus for a filling of the at least one reservoir after the filling of the intake opening has been stopped.

In a development of the production station, the material receptacle is a tube that is functionally connected with a supply pipe, wherein the supply pipe is arranged to provide the production station with particulate magnetocaloric material, while a supply of magnetocaloric material for the material receptacle is controlled by an external device.

In a further development of the production station, a plurality of reservoir is provided, wherein the reservoirs are arranged below the shutter plate in a matrix arrangement and the matrix arrangement is of a structure selected from the group consisting of: a rectangular matrix arrangement, a triangular matrix arrangement, a hexagonal matrix arrangement a circular matrix arrangement. The matrix arrangement of this development can allow an equal filling of the reservoirs with the particulate magnetocaloric material.

In the following, developments of the production arrangement according to the second aspect of the invention will be described.

In a preferred development, the production arrangement is characterized by a pressing unit with a pressing device, in particular wherein the pressing device is arranged at the framework of the production station, and wherein the pressing device is arranged to be pressed against the particulate magnetocaloric material within the reservoirs, in particular wherein the pressing device comprises pressing pins to be pressed against the particulate magnetocaloric material within the reservoirs, and/or a heating device, arranged and adapted to change a particulate structure of the particulate magnetocaloric material by heating the particulate magnetocaloric material within the reservoirs. In a variant of this development, the pressing unit is formed by the pressing framework. In an example of this variant, the pressing unit is configured and arranged to press the pressing pins against the magnetocaloric material in the respective reservoir, after each filling mode that fills the reservoir with magnetocaloric material. In a further example of this variant, the pressing unit is arranged and adapted to press the pressing pins against the magnetocaloric material in the respective reservoir after a last and thus final filling mode that fills the reservoir with magnetocaloric material. In a further variant, the pressing unit is a further device separated from the framework of the plurality of production stations. The heating device of this development can change the particulate structure of the magnetocaloric material and thus help to remove the layered bed of magnetocaloric material out of the at least one reservoir and to provide it in a stable state for using it in magnetocaloric applications, such as in cooling devices or in magnetocaloric power generators.

In a further development the pressing unit is for arrangement at each production framework of the at least two production stations, or at at least one production framework, or at the pressing framework, configured to press the particulate magnetocaloric material within the reservoirs. In this development, a combination of filling and pressing of the particulate magnetocaloric material can lead to a smaller production arrangement and therefore reduce costs of the production of a layered bed of magnetocaloric material.

In a further development, the production arrangement further comprises a user interface in form of a man-machine-interface. In a variant of this development, the user interface is configured to receive a user input, which is indicative of a duration of the filling mode, of a pressing force of the pressing pins, of a kind of magnetocaloric material received at least one of the plurality of product stations, and/or of a manual activation of the filling mode. In a further variant, the user interface is configured to provide information concerning a state of processing of the production arrangement, concerning characteristics of the production arrangement, and/or concerning characteristics of the magnetocaloric material.

In the following, developments of method according to the third aspect of the invention will be described.

In a development of the method, the particulate magnetocaloric material comprises particles of spherical shape wherein the particulate magnetocaloric material comprises spheres of magnetocaloric material each having an adhesive coating. The spherical shape of this development can lead to an advantageously regular structure of bonded layered beds of magnetocaloric material. Furthermore, the adhesive coating of the particulate magnetocaloric material can provide or support a stable state of bonded layered beds of magnetocaloric material for using them in magnetocaloric applications.

In a further development of the method the layered bed of particulate magnetocaloric material within the reservoir is pressed by pressing pins, wherein the pressing pins press against the particulate magnetocaloric material in the reservoir with a pressing force. In a variant of this development, the pressing force is predetermined. In a further variant of this development, the pressing force depends on a height of the particulate magnetocaloric material within the reservoir. In an example of this variant, the particulate magnetocaloric material within the reservoir is pressed down to a constant height, so that the provided layered beds of magnetocaloric material are all equally shaped. Thus, in this example the magnetocaloric material is first dosed into the at least one reservoir and than pressed into a layer with a predetermined constant height by the pressing pins. After such a dosing and pressing, a further layer can be provided by a further dosing of magnetocaloric material of the same or different kind into the at least one reservoir and by a further pressing into the further layer with a further predetermined constant height which can be identical with the predetermined constant height.

In another development of the method, at each production framework, a magnetocaloric material of different kind, in particular of different transition property like e.g. Curie-temperature, is provided. The magnetocaloric materials of different kinds can comprise for instance gadolinium, MnFe- or LaFeSi-based materials. To enable a proper choice of appropriate magnetocaloric material, the whole content of the international patent application PCT/EP2010/061025 is herewith included into this description.

The invention will be apparent from and elucidated with reference to the embodiments described hereinafter.

In the following, the drawing shows in:

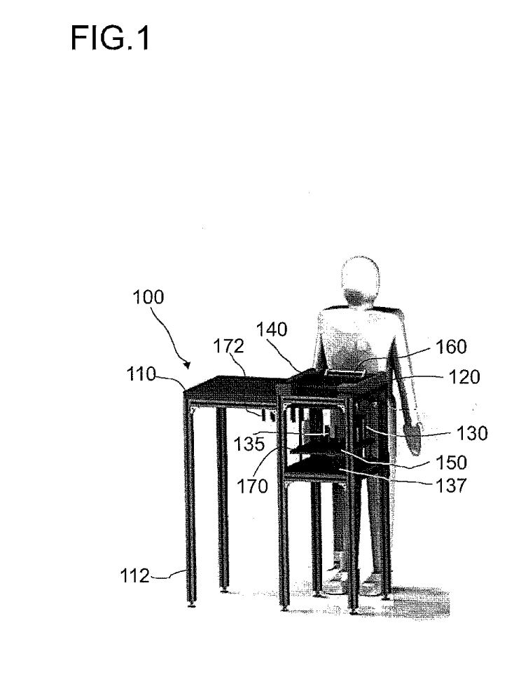

FIG. 1 an illustration of an embodiment of a production station with framework according to a first aspect of the invention,

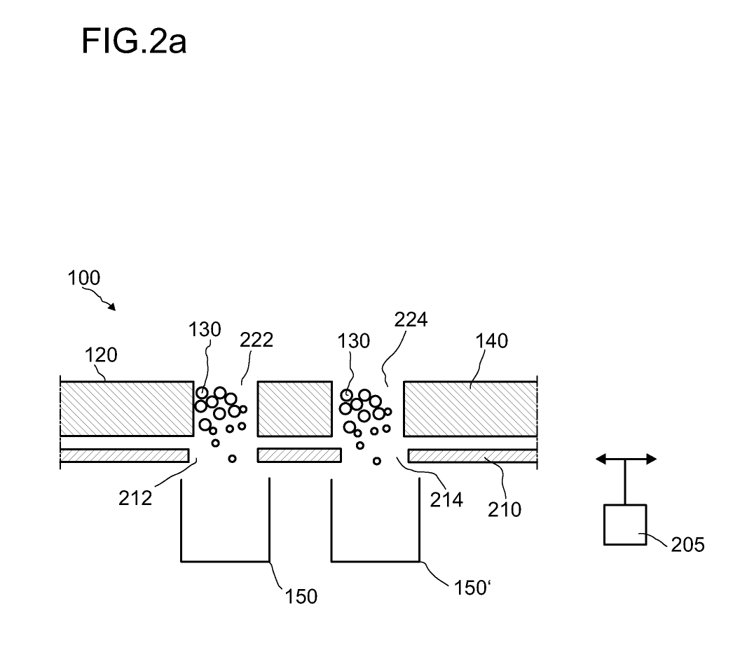

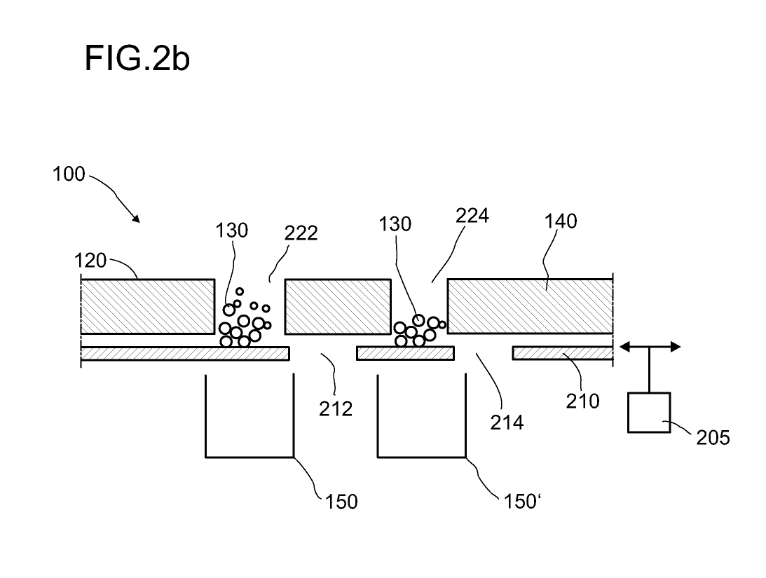

FIG. 2a,b a schematic view of an embodiment of a production station according to the first aspect of the invention with a material box forming a material receptacle and a plurality of reservoirs and a controlling device arranged and adapted to control the shutter plate, wherein FIG. 2a shows a filling modus of the shutter plate with a plurality of further intake opening aligned with a plurality of intake openings of a dosing plate, and wherein FIG. 2b shows a metering modus of the shutter plate with the plurality of further intake openings not-aligned and underneath the plurality of intake openings,

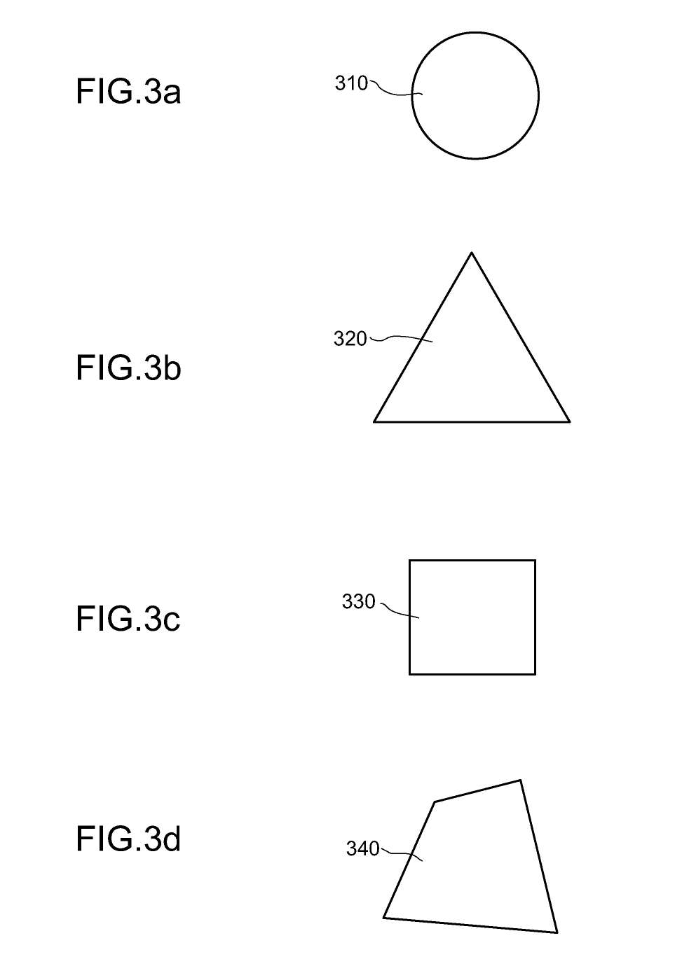

FIG. 3a-d an illustration of four cross-sections of the intake openings of the dosing plate corresponding to four embodiments of the production station according to the first aspect of the invention, wherein FIG. 3a shows a circular cross-section, FIG. 3b shows a triangular cross-section, FIG. 3c shows a quadratic cross-section, and FIG. 3d shows a polygonal cross-section,

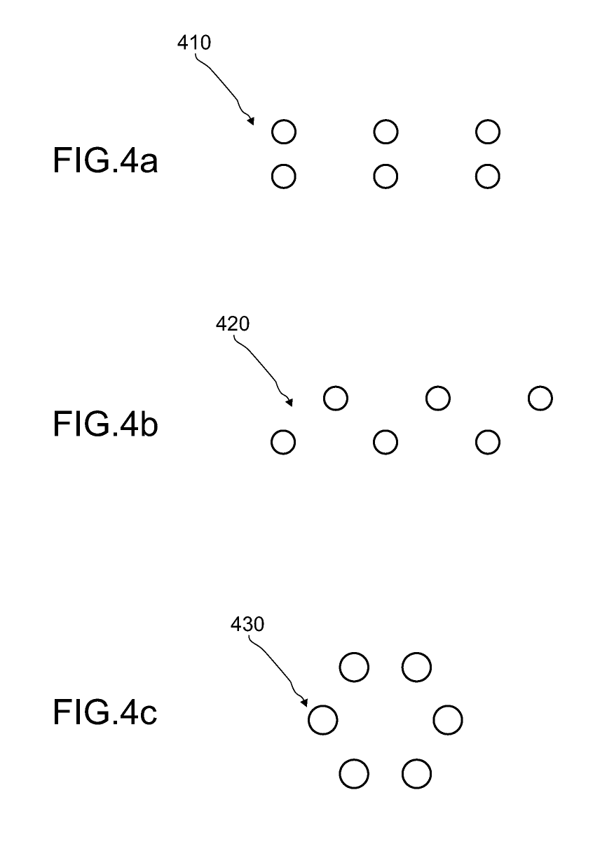

FIG. 4a-c an illustration of three matrix arrangements of the reservoirs corresponding to three embodiments of the production station according to the first aspect of the invention, wherein FIG. 4a shows a rectangular matrix arrangement, FIG. 4b shows a triangular matrix arrangement, and FIG. 4c shows a circular matrix arrangement,

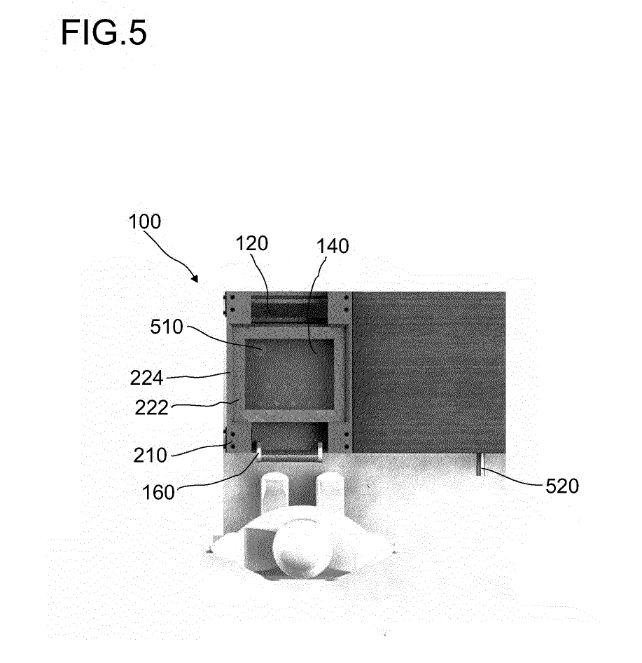

FIG. 5 an illustration of a top view of an embodiment of the production station in the metering modus according to the first aspect of the invention,

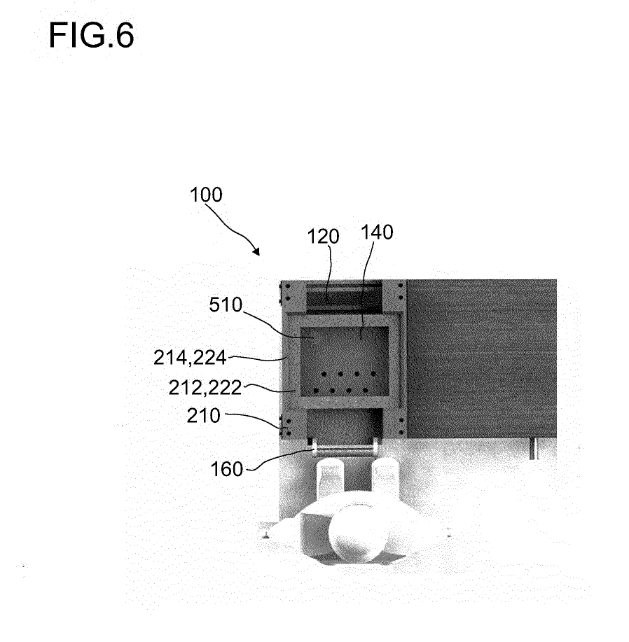

FIG. 6 an illustration of a top view of an embodiment of the production station in the filling modus according to the first aspect of the invention,

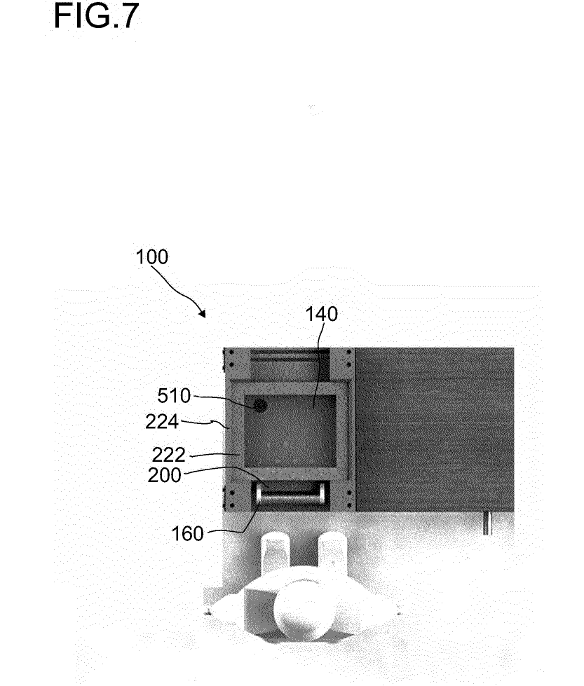

FIG. 7 an illustration of a top view of an embodiment of the production station in an emptying modus according to the first aspect of the invention,

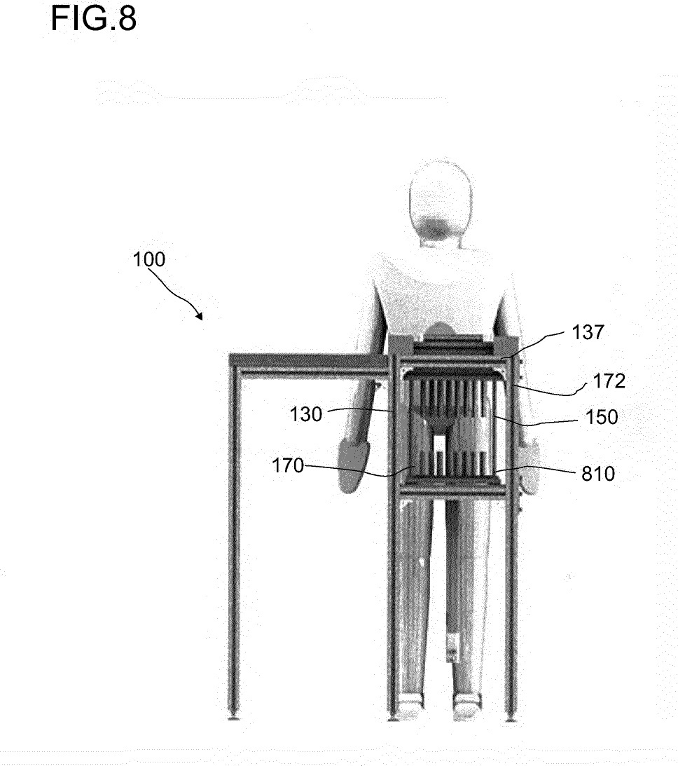

FIG. 8 an illustration of a front view of an embodiment of the production station in a pressing modus according to the first aspect of the invention,

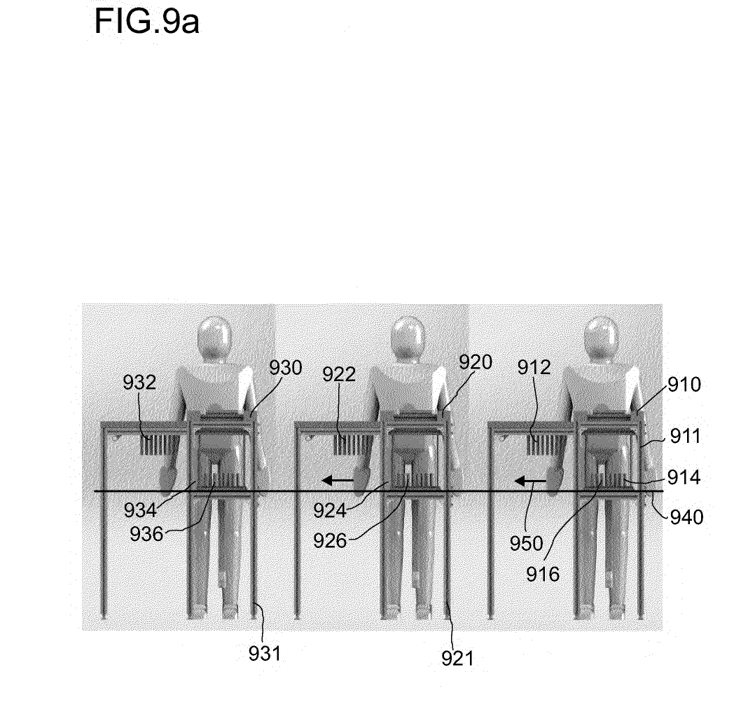

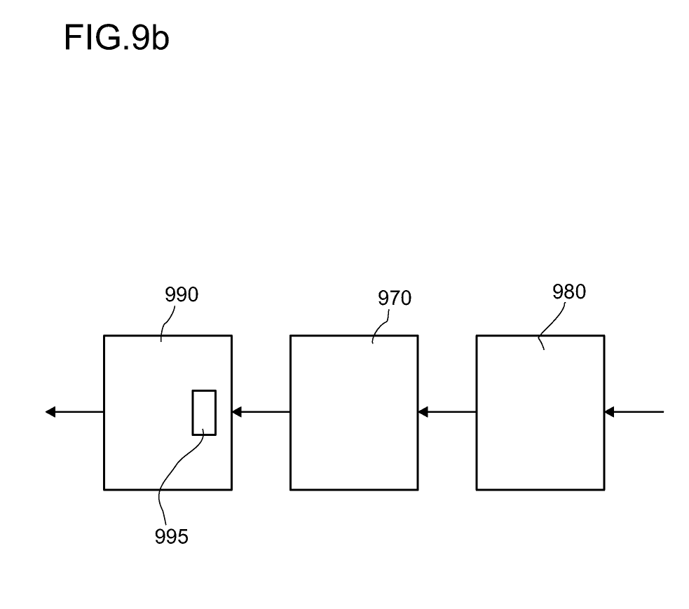

FIG. 9a an illustration of an embodiment of a production arrangement for producing layered beds of magnetocaloric material according to a second aspect of the invention, comprising three production stations,

FIG. 9b an illustration of an embodiment of a production arrangement for producing layered beds of magnetocaloric material according to the second aspect of the invention, comprising an intermediate unit, which separates a pressing unit and a final curing unit,

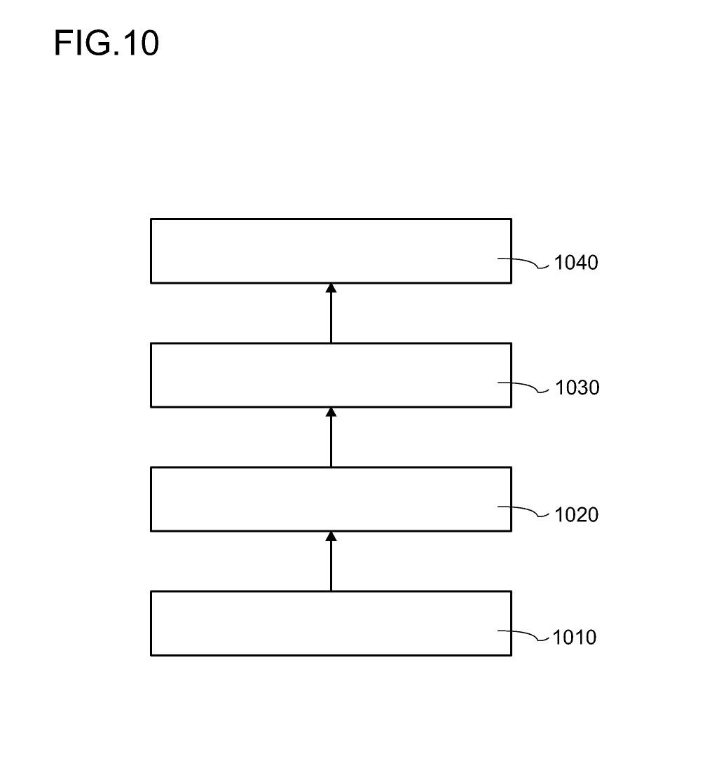

FIG. 10 a schematic illustration of a sequence of steps for a method of producing layered beds of magnetocaloric material according to a third aspect of the invention.

FIG. 1 shows an illustration of an embodiment of a production station 100 with framework 110 according to a first aspect of the invention.

For arrangement at the framework 110, the production station 100 comprises a material receptacle 120, in particular a material box, for receiving a particulate magnetocaloric material 130, and a dosing plate 140 comprising at least one intake opening (shown in FIG. 2) adapted to receive a magnetocaloric material 130 of one or more layers of a layered bed 135 of the particulate magnetocaloric material 130, in particular a plurality of intake openings adapted to receive a plurality of layered beds 135. The production station further comprises at least one reservoir 150 below the at least one intake opening, in particular a plurality of reservoirs 150 below the plurality of intake openings assigned to the plurality of layered beds 135, wherein the reservoir 150 is adapted to receive the one or more layers 135 of the particulate magnetocaloric material 130, and the production station further comprises a shutter plate (shown in FIG. 2) arranged between the reservoir 150 and the dosing plate 140, and the shutter plate being switchable through motion with respect to the dosing plate 140, and the shutter plate being arranged and adapted to at least activate a filling modus of the reservoirs 150 with the particulate magnetocaloric material 130, by a manually moveable switching control 160 of the shutter plate.

In the shown embodiment of the production station 100, an amount of particulate magnetocaloric material 130 in the reservoir 150 after filling of the reservoir 150 in a filling modus of the production station 100 depends on a filling height of particulate magnetocaloric material 130 within the intake opening of the dosing plate before the filling of the reservoirs 150. Furthermore, a flow of particulate magnetocaloric material 130 starts with an activation of the filling of the reservoir 150 in the filling modus of the shutter plate, and ends with emptying the filling height of particulate magnetocaloric material 130 within the intake opening of the dosing plate 140.

The switching control 160 of the shutter plate can also be used to deactivate the filling mode of the reservoirs 150.

The shown embodiment of the production table 100 also comprises at the framework 110 a pressing device 170, comprising pressing pins 172, arranged to be pressed against the particulate magnetocaloric material 130 within the reservoirs 150, and a pressing motor (not shown in FIG. 1), arranged to press the pressing pins 172 against the particulate magnetocaloric material 130 within the reservoirs 150 with a pressing force. The pressing device is further arranged and adapted to provide the pressing force as a force that depends on a height 137 of the particulate magnetocaloric material 130 within the reservoir 150.

The pressing device 170 is further arranged to provide an operation range of different adjustable pressing forces. The pressing pins 172 are arranged to be moved to the reservoir 150 via a rail manually. In an embodiment not shown, the pressing pins are arranged to be moved to the reservoir by means of the pressing motor. In an embodiment not shown, the pressing device is arranged to provide between 5 and 60, preferable 30 different pressing forces.

The framework 110 is made of aluminium and comprises six legs 112. In another embodiment not shown, a framework is used, which comprises no legs and is an integrated part of a production line.

FIG. 2a and FIG. 2b show a schematic view of an embodiment of a production station 100 according to the first aspect of the invention with a material box forming a material receptacle 120 and a plurality of reservoirs 150, 150′ and a controlling device 205 arranged and adapted to control the shutter plate 210.

FIG. 2a shows a filling modus of the shutter plate 210 with a plurality of further intake opening 212, 214 aligned with a plurality of intake openings 222, 224 of a dosing plate 140.

As shown in FIG. 2a, a configuration of the further intake openings 212, 214 as well as a further configuration of the intake openings 222, 224 has to be adapted onto a matrix arrangement of the reservoirs 150, 150′ in order to allow an alignment and thus a flow of the particulate magnetocaloric material 130 into the reservoir 150, 150′.

FIG. 2b shows a metering modus of the shutter plate 210 with the plurality of further intake openings 212, 214 not-aligned and underneath the plurality of intake openings 222, 224 of the dosing plate 140.

Comparing FIG. 2a with FIG. 2b shows that the filling modus can be transferred into the metering modus by shafting a position of the shutter plate 210.

As it is furthermore shown, the metering position of the production station 100 can be used to refill the intake openings 222, 224 with particulate magnetocaloric material 130 for using the magnetocaloric material in a subsequent filling modus.

The shown controlling device 205 is configured to control the way along which the shutter plate 210 is shifted for transferring the filling modus into the metering and vice versa.

Furthermore, the controlling device 205 is configured to control a start of the filling modus or of the metering modus.

FIGS. 3a-d show an illustration of four cross-sections 310, 320, 330, 340 of the intake openings of the dosing plate corresponding to four embodiments of the production station according to the first aspect of the invention.

FIG. 3a shows a circular cross-section 310, FIG. 3b shows a triangular cross-section 320, FIG. 3c shows a quadratic cross-section 330, and FIG. 3d shows a polygonal cross-section 340.

In the corresponding four embodiments of the production station, the respective reservoir is of configuration with a cross-section adapted to the cross-section 310, 320, 330, 340 of the intake opening.

FIGS. 4a-c show an illustration of three matrix arrangements of the reservoirs corresponding to three embodiments of the production station according to the first aspect of the invention.

FIG. 4a shows a rectangular matrix arrangement 410 of the reservoirs.

FIG. 4b shows a triangular matrix arrangement 420 of the reservoirs.

FIG. 4c shows a circular matrix arrangement 430 of the reservoirs.

FIG. 5 shows an illustration of a top view of an embodiment of the production station 100 in the metering modus according to the first aspect of the invention.

The depicted mutual position of the dosing plate 140 with its intake openings 222, 224, and of the further intake openings (not shown in FIG. 5) of the shutter plate 210 correspond to the embodiment shown in FIG. 2b. The shown embodiment is a top view of the production station 100, which is also shown in FIG. 1.

The switching control 160 has been used to shift the shutter plate 210 with the further intake openings relative to the dosing plate 140 so that the further intake openings are not-aligned and underneath the intake openings 222, 224 of the dosing plate 140. It is furthermore shown a discharge opening 510 of the dosing plate 140, which is also not-aligned with a corresponding further discharge opening in the shutter plate 210.

Since the shutter plate 210 in the depicted metering modus closes all openings of the dosing plate on a base of the material receptacle 120, the metering modus of the production station 100 can be used to refill the intake openings 222, 224 with particulate magnetocaloric material for using the magnetocaloric material in a subsequent filling modus of the production station 100.

FIG. 5 also shows a pressing control 520, which is arranged to move the pressing pins (not shown in FIG. 5) to the reservoirs (not shown in FIG. 5) via a rail manually.

FIG. 6 shows an illustration of a top view of an embodiment of the production station 100 in the filling modus according to the first aspect of the invention.

The depicted mutual position of the dosing plate 140 with its intake openings 222, 224, and of the further intake openings 212, 214 of the shutter plate 210 correspond to the embodiment shown in FIG. 2a.

The switching control 160 has been used to shift the shutter plate 210 with the further intake openings relative to the dosing plate 140 so that the further intake openings are aligned with the intake openings 222, 224 of the dosing plate 140. It is furthermore shown a discharge opening 510 of the dosing plate 140, which is not-aligned with a corresponding further discharge opening in the shutter plate 210.

The reservoirs shown in FIG. 1 are aligned with the intake openings 222, 224 of the dosing plate 140. Therefore, if the material receptacle 120 is filled with magnetocaloric material, a switching of the switching control 160 into the filling modus leads to a filling of the reservoirs by magnetocaloric material arranged in the intake openings 222, 224 that falls through the further intake openings of the shutter plate 210 into the reservoirs.

FIG. 7 shows an illustration of a top view of an embodiment of the production station 100 in an emptying modus according to the first aspect of the invention.

As already shown in FIG. 5, the switching control 160 has been used to shift the shutter plate 210 with the further intake openings relative to the dosing plate 140 so that the further intake openings are not-aligned and underneath the intake openings 222, 224 of the dosing plate 140. In contrast to FIG. 5, the discharge opening 510 of the dosing plate 140 is aligned with a corresponding further discharge opening of the shutter plate 210.

A bin (not shown in FIG. 7) is arranged under the discharge opening 510 of the dosing plate 140, so that magnetocaloric material that rests in the material receptacle, in particular after the metering modus and/or deactivation of the filling modus, falls down through the discharge opening 510 of the dosing plate 140 and through the further discharge opening of the shutter plate 210 into the bin. The discharge opening 510 in the shown emptying modus is provided with particulate magnetocaloric material by means of a wiper (not shown in FIG. 7).

FIG. 8 shows an illustration of a front view of an embodiment of the production station 100 in a pressing modus according to the first aspect of the invention.

In comparison to the production station 100 shown in FIG. 1, the pressing pins 172 of the pressing device 170 are arranged at respective reservoirs 150 filled with particulate magnetocaloric material 130. Furthermore, the pressing pins 172 are pressed against the particulate magnetocaloric material 130 within the reservoirs 150 with a pressing force that depends on a height 137 of the particulate magnetocaloric material 130 within the reservoir 150.

The pressing pins 172 are pressed against the particulate magnetocaloric material 130 by an automated upstroke 810, forming a part of the pressing device 170. The automated upstroke 810 is further arranged to provide an operation range of different adjustable pressing forces.

In the shown embodiment, the pressing pins 172 are shifted to the reservoirs 150 manually by the pressing control shown in FIG. 5. After the pressing pins 172 are arranged in a pressing position above the reservoirs 150, the automated upstroke 810 presses the pressing pins 172 against the particulate magnetocaloric material 130 with the pressing force according to a user input received by a user interface (not shown).

FIG. 9a shows an illustration of an embodiment of a production arrangement 900 for producing layered beds of magnetocaloric material according to a second aspect of the invention, comprising three production stations 910, 920, 930.

The three production stations 910, 920, 930 are arranged and adapted as the production station 100 shown in the previous figures, and form a part of a production line 940. Thus all three production stations 910, 920, 930 are identically build, comprise a respective framework 911, 921, 931, a respective pressing device 912, 922, 932 and respective pluralities of reservoirs 914, 924, 934.

The production arrangement 900 furthermore comprises a reservoir shift system 950, arranged and adapted to move at least one plurality of reservoirs 914, 924, 934 from a framework 911, 921, 931 of one production station 910, 920, 930 to a further framework 911, 921, 931 of a further production station 910, 920, 930. In an embodiment not shown, the moving of reservoirs is configured to be provided simultaneously at all production stations.

Each production station 910, 920, 930 of the depicted production arrangement 900 is configured to provide a particulate magnetocaloric material 916, 926, 936 of different kind, in particular of different transition property like e.g. Curie-temperature.

At a final position of the production line 940, the production station 930 forms a transport production framework, moving the pluralities of reservoirs to further processing steps that are physically separated from the shown production line 940.

FIG. 9b shows an illustration of an embodiment of a production arrangement 960 for producing layered beds of magnetocaloric material according to the second aspect of the invention, comprising an intermediate unit 970, which separates a pressing unit 980 and a final curing unit 990.

The intermediate unit 970 and the pressing unit 980 are configured and arranged as the framework shown in the previous figures.

The final curing 990 unit comprises a heating device 995, arranged and adapted to change a particulate structure of the particulate magnetocaloric material by heating the particulate magnetocaloric material within the reservoirs.

FIG. 10 shows a schematic illustration of a sequence of steps for a method of producing layered beds of magnetocaloric material according to a third aspect of the invention.

The method comprises as a first step 1010 a providing of a particulate magnetocaloric material received in a material receptacle.

A further step 1020 comprises a dosing of the particulate magnetocaloric material in the dosing plate, having at least one intake opening adapted to receive a magnetocaloric material of one layer of the layered bed.

A subsequent step 1030 of the method comprises a receiving of the layered bed of the particulate magnetocaloric material, in particular in at least one reservoir below the at least intake opening, in a particular a plurality of reservoirs below the plurality of intake openings assigned to the plurality of layered beds, wherein the reservoir is adapted to receive the layered bed of the particulate magnetocaloric material.

A final step 1040 of the method for producing layered beds of magnetocaloric material comprises a activating, in particular also a deactivating, of a filling modus of the reservoirs with the particulate magnetocaloric material, by switching control of the shutter plate, in particular a shutter plate arranged between the reservoir and the dosing plate and the shutter plate being switchable movable in parallel to the dosing plate and the shutter plate being arranged and adapted to at least activate, in particular also deactivate, a filling modus of the reservoirs with the particulate magnetocaloric material, by switching control of the shutter plate, wherein
an amount of particulate magnetocaloric material in the reservoir after filling of the reservoir in a filling modus of the production station depends on a filling height of particulate magnetocaloric material within the intake opening of the dosing plate before the filling of the reservoirs, and wherein
a flow of particulate magnetocaloric material starts with an activation of the filling of the reservoir in the filling modus of the shutter plate, and wherein the flow of particulate magnetocaloric material ends with emptying the filling height of particulate magnetocaloric material within the intake opening of the dosing plate.

1. A production station adapted for producing at least one layered bed of magnetocaloric materials, the production station comprising:
a framework
a material receptacle for receiving a particulate magnetocaloric material,
a dosing plate, having at least one intake opening adapted to receive a magnetocaloric material of one layer of the layered bed,
at least one reservoir below the at least one intake opening, wherein the reservoir is adapted to receive the one or more layers of the particulate magnetocaloric material, and
a shutter plate arranged between the reservoir and the dosing plate, wherein the shutter plate is switchable through motion with respect to the dosing plate, wherein the shutter plate is arranged and adapted to at least activate a filling modus, and wherein in the filling modus the at least one reservoir is filled with particulate magnetocaloric material of the one layer of the layered bed by a switching control of the shutter plate,
wherein
an amount of particulate magnetocaloric material in the reservoir, after being filled with particulate magnetocaloric material of the one layer of the layered bed in the filling modus of the production station, depends on a filling height of particulate magnetocaloric material within the intake opening of the dosing plate before the filling modus is activated, and
wherein
a flow of particulate magnetocaloric material starts with an activation of the filling of the reservoir in the filling modus of the shutter plate, wherein the flow of particulate magnetocaloric material ends with emptying the intake opening of the dosing plate from a filling height of particulate magnetocaloric material within the intake opening of the dosing plate.

2. The production station of claim 1, further comprising:
a scraper movable across an entrance of the at least on intake opening at the surface of the dosing plate, such that an excess amount of magnetocaloric material situated between the entrance and the material receptacle is removed from the entrance of the at least on intake opening.

3. The production station of claim 1, further comprising:
a bin,
wherein the material receptacle and the dosing plate and/or the shutter plate are further arranged to provide the bin with particulate magnetocaloric material, such that a scraper is arranged to provide the bin with residual particulate magnetocaloric material.

4. The production station according to claim 1,
wherein the shutter plate is being arranged and adapted such that the flow of particulate magnetocaloric material ends before a deactivation of the filling of the reservoirs by the shutter plate, and/or
the shutter plate is being arranged and adapted such that the filling modus of the reservoirs with the particulate magnetocaloric material is deactivated by a further switching control of the shutter plate.

5. The production station according to claim 1,
wherein the reservoir has a cross-sectional configuration, and
wherein the cross-section of the reservoir is adapted to the cross-section of the intake opening.

6. The production station according to claim 1
wherein in a filling modus of the shutter plate, the shutter plate comprises at least one further intake opening aligned with and underneath the plurality of intake openings assigned to the plurality of layered beds, and wherein the reservoir is adapted to receive the one or more layers of the particulate magnetocaloric material through the at least one further intake opening when activated for filling of the reservoirs with the particulate magnetocaloric material, and/or
in a metering modus of the shutter plate, the shutter plate comprises at least one further intake opening wherein the at least one further intake openings are not-aligned and underneath the plurality of intake openings assigned to the plurality of layered beds, and wherein the shutter plate closes the intake openings of the dosing plate when deactivated for filling of the reservoirs with the particulate magnetocaloric material.

7. The production station according to claim 1, further comprising:
a pressing device wherein the pressing device is arranged to be pressed against the particulate magnetocaloric material within the reservoirs.

8. The production station according to claim 1, further comprising:
a controlling device and/or a user interface in form of a man-machine-interface, arranged and adapted to control the shutter plate and/or to control a pressing device.

9. The production station according to claim 1, wherein the reservoir is adapted to vibrate during the filling of the reservoir and/or a mounting frame for mounting the plurality of reservoirs to the framework of the production station is adapted to vibrate during the filling of the reservoirs.

10. A production arrangement for producing layered beds of magnetocaloric material, the production arrangement comprising:
at least two production stations according to claim 1, wherein:
at least one plurality of reservoirs is arranged movable from one production station to another production station of the at least two production stations, and
a reservoir shift system arranged and adapted to move the at least one plurality of reservoirs from a first framework of said one production station to a second framework of said another production station or to a pressing framework, comprising a pressing device.

11. The production arrangement according to claim 10 further comprising:
a pressing unit with a pressing device, wherein the pressing device is arranged to be pressed against the particulate magnetocaloric material within the reservoirs, and/or
a heating device, arranged and adapted to change a particulate structure of the particulate magnetocaloric material by heating the particulate magnetocaloric material within the reservoirs.

12. A method for producing one or more layered beds of magnetocaloric material using the production station of claim 1, the method comprising:
providing a particulate magnetocaloric material received in a material receptacle,
dosing the particulate magnetocaloric material in the dosing plate, having at least one intake opening adapted to receive a magnetocaloric material of one layer of the layered bed,
receiving the layered bed of the particulate magnetocaloric material in at least one reservoir below the at least one intake opening, wherein the reservoir is adapted to receive the one or more layers of the particulate magnetocaloric material, and
activating a filling modus of the reservoirs with the particulate magnetocaloric material, by switching control of the shutter plate, wherein the shutter plate is switchable through motion with respect to the dosing plate, wherein the shutter plate is arranged and adapted to at least activate the filling modus, and wherein in the filling modus the at least one reservoir is filled with particulate magnetocaloric material of the one layer of the layered bed by a switching control of the shutter plate,
wherein
an amount of particulate magnetocaloric material in the reservoir after filling of the reservoir in a filling modus of the production station depends on a filling height of particulate magnetocaloric material within the intake opening of the dosing plate before the filling of the reservoirs, and
wherein
a flow of particulate magnetocaloric material starts with an activation of the filling of the reservoir in the filling modus of the shutter plate, wherein the flow of particulate magnetocaloric material ends with emptying the intake opening of the dosing plate from a filling height of particulate magnetocaloric material within the intake opening of the dosing plate.

13. The method of claim 12,
wherein the particulate magnetocaloric material comprises particles of spherical shape, and
wherein the particulate magnetocaloric material comprises spheres of magnetocaloric material each having an adhesive coating.

14. The method of claim 11,
wherein the particulate magnetocaloric material within the reservoir is pressed by a pressing device, and
wherein the pressing device presses against the particulate magnetocaloric material in the reservoir with a pressing force.

15. The method according to claim 11,
wherein at each production framework, a magnetocaloric material of different kind, is provided.
